(19) United States
(12) Patent Application Publication
(10) Pub. No.: US 2020/0200980 A1
(43) Pub. Date: Jun. 25, 2020

(54) OPTICAL CONNECTOR

(71) Applicant: Japan Aviation Electronics Industry, Limited, Tokyo (JP)

(72) Inventors: Yuichi KOREEDA, Tokyo (JP); Masaki ISHIGURO, Tokyo (JP); Masayoshi KAGAWA, Tokyo (JP)

(21) Appl. No.: 16/806,368

(22) Filed: Mar. 2, 2020

Related U.S. Application Data
(63) Continuation of application No. PCT/JP2018/028840, filed on Aug. 1, 2018.

(30) Foreign Application Priority Data
Nov. 22, 2017 (JP) 2017-224531

(51) Int. Cl. G02B 6/38

(52) U.S. Cl. CPC G02B 6/3887; G02B 6/3829; G02B 6/3823; G02B 6/3821

(57) ABSTRACT

An optical connector includes a connector housing that holds a ferrule such that the ferrule is allowed to move backward along a connecting direction, and the optical fiber in the connector housing has at least one loop element each having a tangential line along the connecting direction and a pair of tangential line portions connected to the at least one loop element and is held in such a manner as not to prevent a radius of curvature of the at least one loop element from becoming larger as the ferrule moves backward along the connecting direction.

### BACKGROUND OF THE INVENTION

The present invention relates to an optical connector, in particular, to an optical connector that allows a ferrule to move backward when the optical connector is connected.

FIG. 13 shows a structure of a conventional optical connector 2 attached to an end of an optical cable 1 as disclosed in JP 2000-235132 A. The optical connector 2 has a ferrule 4 disposed at a tip end of an optical fiber 3 drawn from the optical cable 1 and a connector housing 5 that holds the ferrule 4. The tip end of the optical fiber 3 is held by the ferrule 4 while being inserted into the ferrule 4.

When the optical connector 2 is connected to an optical module disposed in a communication device or the like or a counter optical connector attached to another optical cable or the like, a tip end surface of the ferrule 4 abuts against an optical reference plane corresponding to, for example, an end surface of a ferrule in the counter optical connector.

At this time, in order to prevent connection loss, it is necessary to press the ferrule 4 against the optical reference plane in the counter optical connector with sufficient force. To cope with it, the ferrule 4 is held in the connector housing 5 in such a manner as to be allowed to move backward with respect to a connecting direction D1, and a spring 6 that presses the ferrule 4 forward along the connecting direction D1 is disposed in the connector housing 5.

When the optical connector 2 is connected to the counter optical connector, as shown in FIG. 14, the ferrule 4 is pressed by the ferrule in the counter optical connector and moves backward by a distance ΔL in an opposite direction to the connecting direction D1 while elastically compressing the spring 6. As a result, the ferrule 4 and the ferrule in the counter optical connector make contact with each other at a predetermined contact pressure, whereby optical connection of the optical fiber 3 is established.

However, since the ferrule 4 moves backward in the opposite direction to the connecting direction D1, as shown in FIG. 14, the optical fiber 3 drawn from the optical cable 1 bends in the connector housing 5, thereby forming a bending portion 7 in the optical fiber 3. The bending portion 7 is a portion where a radius of curvature of the optical fiber 3 becomes smaller than that of the optical fiber 3 when the optical connector 2 is not connected, and in a case where the radius of curvature of the optical fiber 3 locally becomes smaller than the minimum allowable radius of the optical fiber 3, transmission loss of the optical fiber 3 becomes larger, disadvantageously.

### SUMMARY OF THE INVENTION

The present invention has been made to overcome such a conventional problem and is aimed at providing an optical connector capable of preventing an increase in transmission loss while allowing a ferrule to move backward when the optical connector is connected.

An optical connector according to the present invention is a connector allowing a ferrule holding a tip end portion of an optical fiber to move backward along a connecting direction when the optical connector is connected along the connecting direction, the optical connector comprising:
a connector housing that holds the ferrule such that the ferrule is allowed to move backward along the connecting direction,
wherein the optical fiber in the connector housing comprises at least one loop element each having a tangential line along the connecting direction and a tangential line portion connected to the at least one loop element and is held in such a manner as not to prevent a radius of curvature of the at least one loop element from becoming larger as the ferrule moves backward along the connecting direction.

### BRIEF DESCRIPTION OF THE DRAWINGS

FIG. 1 is a perspective view showing an optical connector according to Embodiment 1 of the present invention.

FIG. 2 is a front view showing the optical connector according to Embodiment 1.

FIG. 3 is a cross-sectional view taken along line A-A in FIG. 2.

FIG. 4 is a perspective view schematically showing an optical fiber in a connector housing of the optical connector according to Embodiment 1.

FIG. 5 is an enlarged view of an important part of FIG. 3.

FIG. 6 is a perspective view showing the optical connector of Embodiment 1 when the optical connector is connected to a counter optical connector.

FIG. 7 is a plan view showing the optical connector of Embodiment 1 when the optical connector is connected to the counter optical connector.

FIG. 8 is a cross-sectional view taken along line B-B in FIG. 7.

FIG. 9 is an enlarged view of an important part of FIG. 8.

FIG. 10 is a perspective view schematically showing an optical fiber in a connector housing of an optical connector according to Embodiment 2.

FIG. 11 is a perspective view schematically showing an optical fiber in a connector housing of an optical connector according to Embodiment 3.

FIG. 12 is a perspective view showing an optical connector according to Embodiment 4.

FIG. 13 is a cross-sectional side view of a conventional optical connector when the optical connector is not connected.

FIG. 14 is a cross-sectional side view of the conventional optical connector when the optical connector is connected.

### DETAILED DESCRIPTION OF THE INVENTION

Embodiments of the present invention are described below based on the appended drawings.

### Embodiment 1

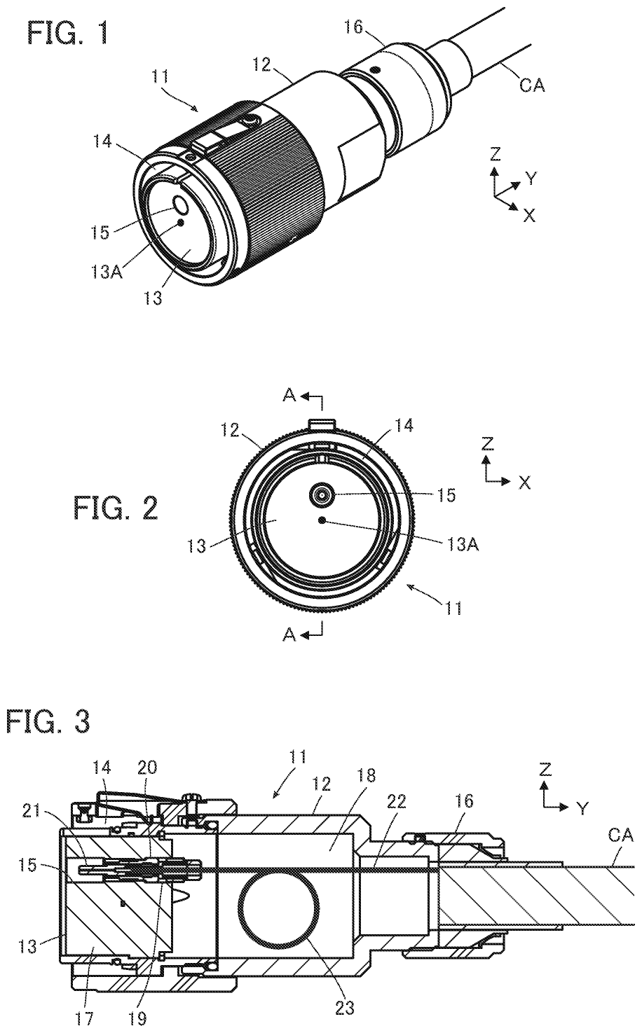

FIGS. 1 and 2 show a configuration of an optical connector 11 according to Embodiment 1 of the present invention. The optical connector 11 is attached to an end of an optical cable CA and has a connector housing 12 of a substantially cylindrical shape.

A connector front surface portion 13 of a circular shape is disposed at one end of the connector housing 12 positioned on the opposite side to a connection portion between the connector housing 12 and the optical cable CA, and a counter optical connector accommodating portion 14 of an annular and recessed shape for accommodating a part of a counter optical connector (not shown) is formed around the connector front surface portion 13. In the connector front surface portion 13, a counter ferrule insertion hole 15 into which a ferrule of the counter optical connector is inserted is formed at a position deviated from a center 13A of the connector front surface portion 13 of a circular shape.

An optical cable fixing portion 16 for fixing the optical cable CA is disposed at the other end of the connector housing 12 positioned on the side of the connection portion between the connector housing 12 and the optical cable CA.

For convenience, the direction from the connector front surface portion 13 to the optical cable fixing portion 16 along the connector housing 12 of a substantially cylindrical shape is called “+Y direction,” the direction from the center 13A to the counter ferrule insertion hole 15 in the connector front surface portion 13 “+Z direction,” and the direction perpendicular to a YZ plane “X direction.”

As shown in FIG. 3, the −Y directional end of the inside of the connector housing 12 is closed by a columnar member 17, and an optical fiber accommodating space 18 is formed between the columnar member 17 and the optical cable fixing portion 16. An end surface of the columnar member 17 on the −Y direction side forms the connector front surface portion 13, and a through-hole 19 communicating with the counter ferrule insertion hole 15 and extending in the Y direction is formed in the columnar member 17. The through-hole 19 opens to the optical fiber accommodating space 18, a ferrule holding member 20 of a substantially cylindrical shape is fixed in the through-hole 19, and a ferrule 21 is held by the ferrule holding member 20.

An optical fiber 22 drawn from the optical cable CA in the −Y direction forms a loop 23 in the optical fiber accommodating space 18, and a −Y directional tip end portion of the optical fiber 22 is held by the ferrule 21.

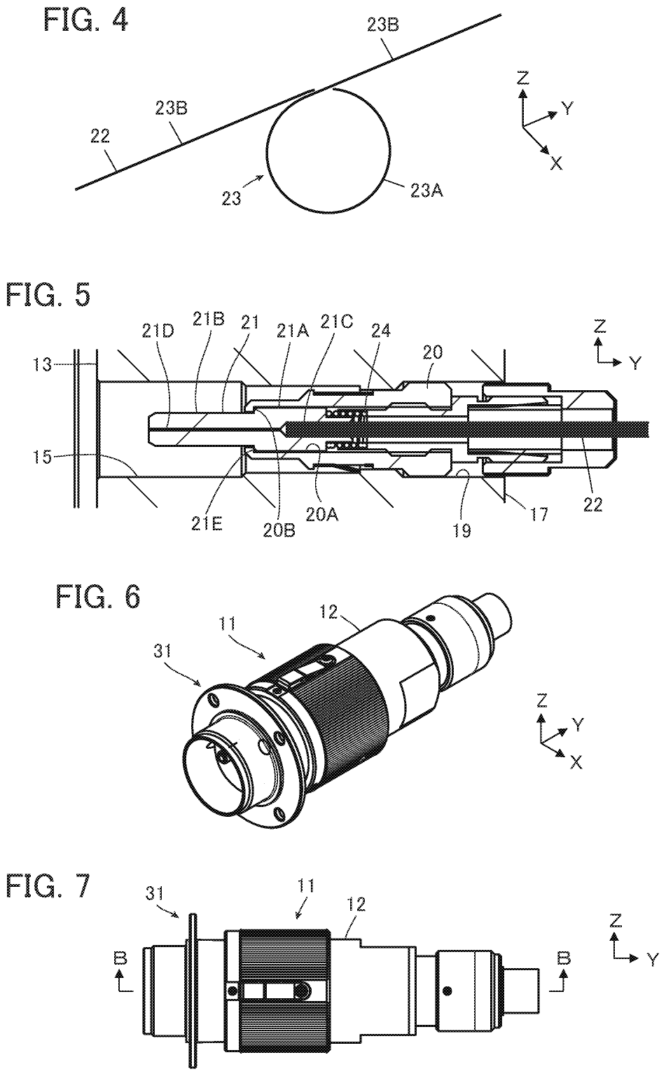

The optical fiber 22 is accommodated in the optical fiber accommodating space 18 in such a manner as not to make contact with an inner wall of the optical fiber accommodating space 18, and as shown in FIG. 4, the loop 23 of the optical fiber 22 is a one-turn loop constituted of a single loop element 23A having a tangential line in the Y direction. The optical fiber 22 in the optical fiber accommodating space 18 is constituted of the loop element 23A and a pair of tangential line portions 23B that are connected to the loop element 23A and extend along the Y direction that is a connecting direction of the optical connector 11. The loop element 23A has a radius of curvature larger than a minimum allowable radius of the optical fiber 22.

As shown in FIG. 5, the ferrule holding member 20 disposed in the through-hole 19 is provided with a ferrule accommodating portion 20A that is a through-hole extending in the Y direction and having a constant inner diameter, and a −Y directional end of the ferrule accommodating portion 20A is provided with a narrowed portion 20B of an annular shape having an inner diameter smaller than that of the ferrule accommodating portion 20A.

The ferrule 21 is a substantially columnar member extending in the Y direction and has a rear half portion 21A on the +Y direction side and a front half portion 21B on the −Y direction side. The −Y directional tip end portion of the optical fiber 22 is held by the ferrule 21 with a fiber core wire portion of the optical fiber 22 being inserted into a core wire portion insertion hole 21C that is formed along the Y direction in the rear half portion 21A of the ferrule 21 and a fiber element wire portion of the optical fiber 22 being inserted into an element wire portion insertion hole 21D that is formed along the Y direction in the front half portion 21B and communicates with the core wire portion insertion hole 21C.

The rear half portion 21A of the ferrule 21 has an outer diameter slightly smaller than the inner diameter of the ferrule accommodating portion 20A of the ferrule holding member 20 and larger than the inner diameter of the narrowed portion 20B, while the front half portion 21B has an outer diameter slightly smaller than that of the narrowed portion 20B of the ferrule holding member 20, and a step 21E of an annular shape is formed at a boundary portion between the rear half portion 21A and the front half portion 21B. The ferrule 21 is held by the ferrule holding member 20 in a movable manner in the Y direction with the rear half portion 21A being accommodated in the ferrule accommodating portion 20A and the front half portion 21B penetrating the narrowed portion 20B and protruding from the ferrule accommodating portion 20A in the −Y direction.

Further, a spring 24 for elastically pressing the ferrule 21 in the −Y direction is disposed in the ferrule holding member 20, and unless an external force is applied to the ferrule 21, the ferrule 21 has the step 21E pressed against the narrowed portion 20B of the ferrule holding member 20. Meanwhile, the optical connector 11 is configured such that when an external force larger than an elastic force of the spring 24 and exerting in the +Y direction is applied to the ferrule 21, the ferrule 21 is allowed to move backward, i.e., in the +Y direction.

When the ferrule 21 moves backward in the +Y direction, the −Y directional tip end portion of the optical fiber 22 held by the ferrule 21 also moves backward in the +Y direction together with the ferrule 21. The optical connector 11 is configured such that at this time, the radius of curvature of the loop element 23A of the loop 23 becomes larger according to a distance of the backward movement. Further, the optical fiber 22 is accommodated in the optical fiber accommodating space 18 in such a manner as not to make contact with the inner wall of the optical fiber accommodating space 18 even when the radius of curvature of the loop element 23A becomes larger in this manner, while the radius of curvature of the loop element 23A is prevented from becoming larger.

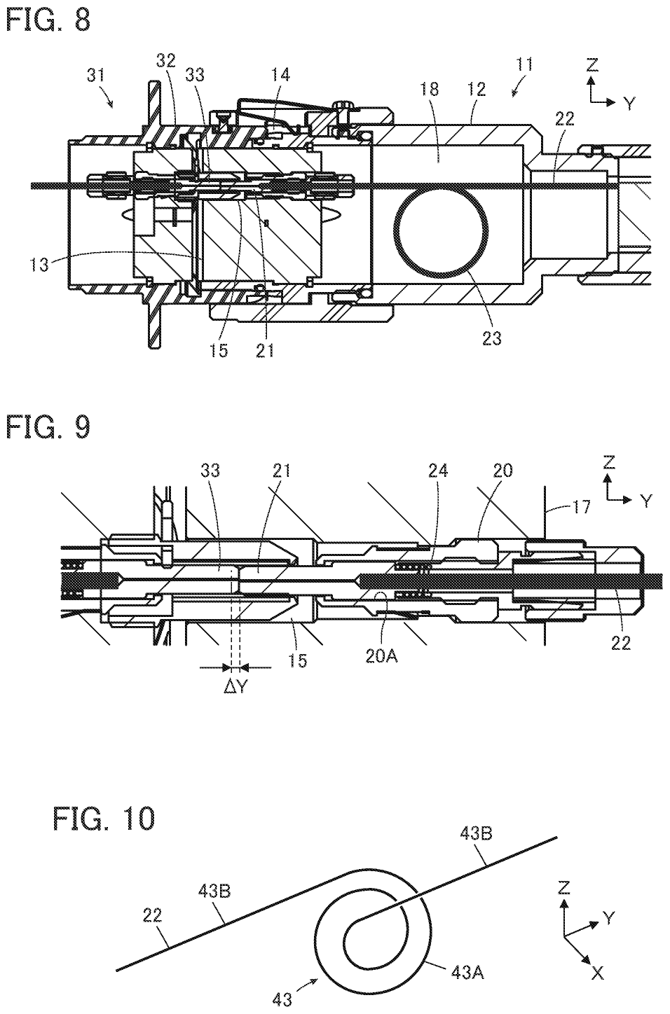

When a counter optical connector 31 is connected to a −Y directional end of the optical connector 11 along the Y direction as shown in FIGS. 6 and 7, as shown in FIG. 8, a +Y directional end of an annular shape of a connector housing 32 of the counter optical connector 31 is inserted into the counter optical connector accommodating portion 14 of a recessed shape of the connector housing 12 of the optical connector 11, and a ferrule 33 of the counter optical connector 31 is inserted into the counter ferrule insertion hole 15 of the optical connector 11.

At this time, as shown in FIG. 9, a +Y directional end surface of the ferrule 33 of the counter optical connector 31 inserted into the counter ferrule insertion hole 15 of the optical connector 11 abuts against a −Y directional end surface of the ferrule 21 of the optical connector 11, and an external force larger than the elastic force of the spring 24 and exerting in the +Y direction is applied to the ferrule 21 of the optical connector 11. Therefore, the spring 24 disposed in the ferrule holding member 20 is elastically compressed, and as compared to when the optical connector 11 is not connected to the counter optical connector 31, the ferrule 21 moves by a distance ΔY in the +Y direction, that is, moves backward by the distance ΔY along the Y direction that is the connecting direction for connecting the optical connector 11 and the counter optical connector 31.

As the ferrule 21 moves backward in the +Y direction, the −Y directional tip end portion of the optical fiber 22 held by the ferrule 21 also moves backward by the distance ΔY in the +Y direction together with the ferrule 21. As a result, the entire length of the optical fiber 22 accommodated in the optical fiber accommodating space 18 increases by a length corresponding to the distance ΔY. In the optical fiber accommodating space 18, the optical fiber 22 forms the one-turn loop 23 constituted of a single loop element 23A that has a tangential line in the Y direction and is disposed in the YZ plane, and the radius of curvature of the loop element 23A becomes larger according to the increase in length of the optical fiber 22. Therefore, it is possible to prevent increase in transmission loss of the optical fiber 22 caused by the backward movement of the ferrule 21.

When the optical connector 11 and the counter optical connector 31 are disconnected from each other, the ferrule 21 is returned to the state where the step 21E is pressed against the narrowed portion 20B of the ferrule holding member 20 by the elastic force of the spring 24 as shown in FIG. 5, and the radius of curvature of the loop element 23A of the optical fiber 22 is also returned to an initial value.

### Embodiment 2

While the optical fiber 22 accommodated in the optical fiber accommodating space 18 of the connector housing 12 has the one-turn loop 23 composed of a single loop element 23A disposed along the YZ plane in Embodiment 1 described above, the invention is not limited thereto. For example, as shown in FIG. 10, the optical fiber 22 accommodated in the optical fiber accommodating space 18 may form a spiral loop 43 disposed in the YZ plane. The loop 43 has a plurality of loop elements 43A each having a tangential line in the Y direction and a different radius of curvature, the optical fiber 22 in the optical fiber accommodating space 18 is constituted of the plurality of loop elements 43A and a pair of tangential line portions 43B extending along the Y direction that is the connecting direction of the optical connector 11. As with the loop element 23A, each of the loop elements 43A has a radius of curvature larger than the minimum allowable radius of the optical fiber 22.

Even when the optical fiber 22 has such a spiral loop 43, as with Embodiment 1, the radius of curvature of each of the loop elements 43A of the loop 43 becomes larger as the ferrule 21 moves backward when the optical connector 11 is connected to the counter optical connector 31, whereby an increase in transmission loss of the optical fiber 22 can be prevented.

### Embodiment 3

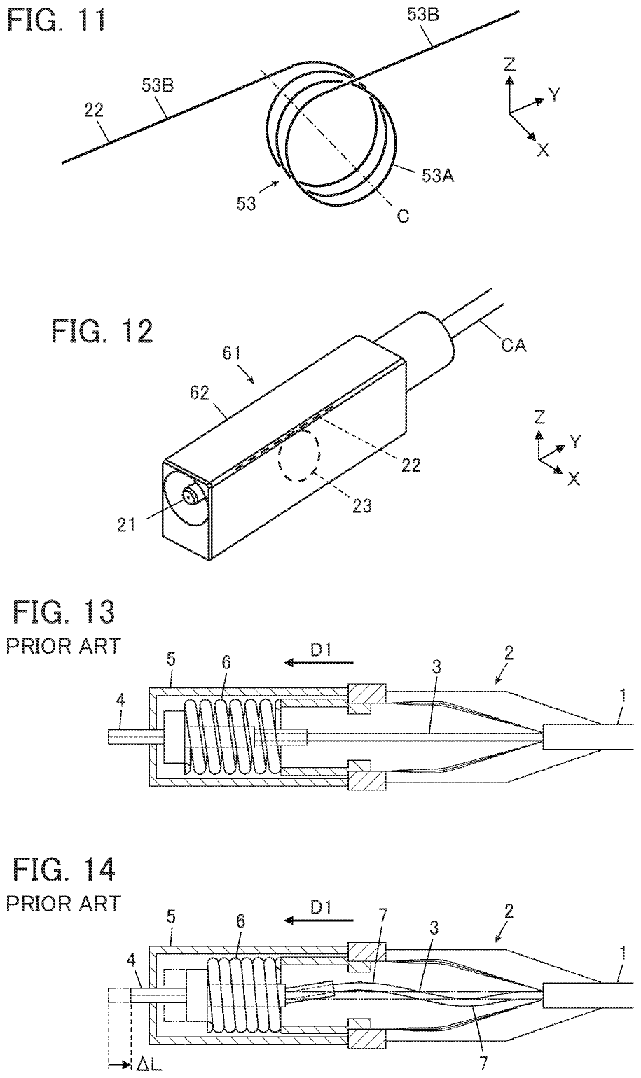

While the optical fiber 22 accommodated in the optical fiber accommodating space 18 of the connector housing 12 has the one-turn loop 23 disposed in the YZ plane or the spiral loop 43 disposed in the YZ plane in Embodiments 1 and 2 described above, the invention is not limited thereto. For example, as shown in FIG. 11, the optical fiber 22 accommodated in the optical fiber accommodating space 18 may form a helical loop 53 having a central axis C in the X direction perpendicular to the YZ plane. The loop 53 has a plurality of loop elements 53A each having a tangential line in the Y direction and all having the same radius of curvature, and the optical fiber 22 in the optical fiber accommodating space 18 is constituted of the plurality of loop elements 53A and a pair of tangential line portions 53B extending along the Y direction that is the connecting direction of the optical connector 11. As with the loop element 23A or 43A, each of the loop elements 53A has a radius of curvature larger than the minimum allowable radius of the optical fiber 22.

Even when the optical fiber 22 has such a helical loop 53, as with Embodiments 1 and 2, the radius of curvature of the loop elements 53A of the loop 53 becomes larger as the ferrule 21 moves backward when the optical connector 11 is connected to the counter optical connector 31, whereby an increase in transmission loss of the optical fiber 22 can be prevented.

The helical loop 53 may have a plurality of loop elements each having a different radius of curvature instead of the plurality of loop elements 53A all having the same radius of curvature.

### Embodiment 4

FIG. 12 shows an optical connector 61 according to Embodiment 4. In the optical connector 61, a connector housing 62 of a so-called rectangular tube shape having a substantially rectangular sectional shape along the XZ plane is used instead of the connector housing 12 of a substantially cylindrical shape in the optical connector 11 of Embodiment 1, and the other components are the same as those in the optical connector 11.

As shown in FIGS. 3 and 4, the loop 23 of the optical fiber 22 in Embodiment 1 is disposed along the YZ plane, and the radius of curvature of the loop element 23A of the loop 23 becomes larger in the YZ plane even when the ferrule 21 moves backward. Thus, when the connector housing 62 has a Y directional length and a Z directional height that are sufficient to accommodate the loop 23, the optical fiber 22 can be held in such a manner as not to make contact with an inner wall of an optical fiber accommodating space in the connector housing 62 while the radius of curvature of the loop element 23A is not prevented from becoming larger. Therefore, the connector housing 62 of a rectangular tube shape can be used.

On the other hand, since, in the conventional optical fiber 2 shown in FIGS. 13 and 14, the direction in which the bending portion 7 of the optical fiber 3 is formed when the ferrule 4 moves backward cannot be defined, the connector housing 5 of a cylindrical shape is required to be used such that the optical fiber 3 can be bent in any direction.

Since the connector housing 62 of a rectangular tube shape is used in Embodiment 4, the optical connector 61 having more excellent space utilization efficiency than that of the connector housing of a cylindrical shape can be achieved.

Since the spiral loop 43 in Embodiment 2 described above is also disposed in the YZ plane as shown in FIG. 10, the optical connector using the connector housing of a rectangular tube shape can similarly be achieved.

Further, while the helical loop 53 in Embodiment 3 has the central axis C in the X direction perpendicular to the YZ plane as shown in FIG. 11, since each of the plurality of loop elements 53A forming the loop 53 is disposed substantially along a YZ plane, as long as the connector housing has an X directional width sufficient to accommodate the helical loop 53, the optical connector having the connector housing of a rectangular tube shape can be achieved.

What is claimed is:

1. An optical connector that allows a ferrule holding a tip end portion of an optical fiber to move backward along a connecting direction when the optical connector is connected along the connecting direction, the optical connector comprising:
a connector housing that holds the ferrule such that the ferrule is allowed to move backward along the connecting direction,
wherein the optical fiber in the connector housing comprises at least one loop element each having a tangential line along the connecting direction and a pair of tangential line portions connected to the at least one loop element and is held in such a manner as not to prevent a radius of curvature of the at least one loop element from becoming larger as the ferrule moves backward along the connecting direction.

2. The optical connector according to claim 1,
wherein the at least one loop element consists of a loop element, and
wherein the optical fiber forms within the connector housing a one-turn loop that is disposed in a plane including the connecting direction and that is constituted of the loop element.

3. The optical connector according to claim 1,
wherein the at least one loop element consists of a plurality of loop elements, and
wherein the optical fiber forms within the connector housing a spiral loop that is disposed in a plane including the connecting direction and that has the plurality of loop elements.

4. The optical connector according to claim 1,
wherein the at least one loop element consists of a plurality of loop elements, and
wherein the optical fiber forms, within the connector housing, a helical loop that has a central axis perpendicular to a plane including the connecting direction and that has the plurality of loop elements.

5. The optical connector according to claim 1, further comprising a spring disposed in the connector housing and configured to press the ferrule forward along the connecting direction.

6. The optical connector according to claim 1, wherein the connector housing has a rectangular tube shape.
